(19) United States
(12) Patent Application Publication
(10) Pub. No.: US 2011/0023131 A1
(43) Pub. Date: Jan. 27, 2011

(54) Method and Apparatus for Checking Aggregated Web Services

(75) Inventors: Johan Hjelm, Tokyo (JP); Theo Gerrit Kanter, Ronninge (SE); Mattias Lidstrom, Stockholm (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/863,925

(22) PCT Filed: Jan. 24, 2008
(86) PCT No.: PCT/SE2008/050080

§ 371 Date: Oct. 6, 2010

(51) Int. Cl. G06F 21/00

(52) U.S. Cl. 726/29

(57) ABSTRACT

Method and apparatus for checking an aggregated web service requested by a terminal user (200). A web service authentication node (208) receives and stores a published description of the aggregated web service, as offered from a primary web service provider (204) and involving one or more sub-services offered from one or more secondary web service providers (206a,b). When the authentication node (208) receives a request made by the user for the aggregated web service, it is checked whether the sub-services and secondary service providers of the aggregated web service are acceptable for the user according to a policy of the user. If all sub-services and secondary service providers are deemed acceptable or safe, the aggregated web service can be authenticated. Otherwise, the request is rejected or the user is warned that the aggregated web service is deemed unsafe. Thereby, access to sensitive user data by secondary service providers can be controlled and made visible.

### TECHNICAL FIELD

The present invention relates generally to a method and arrangement for checking web services requested by terminal users in a communication network access, when the web services involve plural service providers.

### BACKGROUND

A multitude of different services have been developed for communication terminals, with packet-based multimedia communication using IP (Internet Protocol). Multimedia services typically involve the transmission of media in different formats and combinations over IP networks. IP enabled mobile or fixed terminals may exchange media such as visual and/or audio information with other parties over the Internet. In particular, so-called “web-services” are being offered from various web service providers over the Internet.

A network architecture called IMS (IP Multimedia Subsystem) has been developed by the 3^{rd} Generation Partnership Project (3GPP) as a platform for handling and controlling IP based multimedia services and sessions, commonly referred to as the IMS network. Thus, an IMS network can be used to set up and control multimedia sessions for communication terminals connected to various access networks, regardless of the access technology used.

Multimedia sessions are handled by specific session control nodes in the IMS network, e.g. the nodes P-CSCF (Proxy Call Session Control Function), S-CSCF (Serving Call Session Control Function), and I-CSCF (Interrogating Call Session Control Function). Further, a database node HSS (Home Subscriber Server) is used in the IMS network for storing subscriber and authentication data. The IMS network may include various application servers and may also be connected to external providers of web services.

Some web services offered to terminal users from a single “visible” web service provider, may require the execution of a plurality of sub-services enabled by further web service providers in the background, which are thus not visible to the end-user. These sub-services can be combined by using so-called “BPEL (Business Process Execution Language) scripts”, to create an aggregated web service of the existing sub-services. A BPEL script basically defines a succession of sub-services to be executed in order to provide a particular aggregated web service. Thus, an end-user is not necessarily directly involved when consuming a sub-service. FIG. 1 illustrates this situation schematically.

A user of a terminal 100 may subscribe to a certain web service from a web service provider 102, which in this context can be called a “primary service provider” by being visible to the end-user. For example, the user may access the web service from web service provider 102 by accessing a node referred to as “WRVN” (Web-service Rendez-Vous Node), not shown here, basically acting as a web service portal, where a function called UDDI (Universal Description Discovery and Integration) or similar may be implemented which the user can query in search for web services.

The primary service provider 102 may typically provide for a certain degree of security and privacy towards the end-user, e.g. by offering a protected communication link and by requiring registration and a user account name and associated password for authentication of the user. Primary service provider 102 may also require the user to provide certain information on himself/herself in order to deliver the web service. The connection between terminal 100 and primary service provider 102 is therefore indicated as “safe” in the figure, from the user's perspective.

To deliver the requested web service, the primary service provider 102 may also need further information which the primary service provider 102 can obtain by consuming further web services (i.e. sub-services) from three other web service providers 104 in the background. In this context, service providers 104 can be called “secondary service providers”, “back-end service providers” or “sub-service providers”, by being invisible to the user. In order to obtain that information, primary service provider 102 may need to supply potentially sensitive information to the secondary service providers 104, such as for example the user's current position, preferences, terminal capabilities, or basically any context information of the user.

However, since the secondary service providers 104 and their sub-services are invisible to the user, he/she will also be totally unaware of what information the primary service provider 102 may need to share with the secondary service providers 104 for obtaining the sub-services and providing the requested web service. It is also not known to the user whether any authentication procedures are followed, or if a secure communication link is used. The connections between primary service provider 102 and secondary service providers 104 are therefore indicated as “potentially unsafe” in the figure, from the user's perspective. Furthermore, a secondary service provider 104 may in turn consume further web services from other web service providers (not shown) which may involve the submission of potentially sensitive information, out of control even for the primary service provider 102. This is schematically indicated by the dashed arrows in the figure.

By way of example, if the user subscribes to a service of suggested clothing to wear during the day, the primary service provider may in turn obtain a web service with weather information from one secondary service provider (e.g. a weather forecast institute), and also obtain another web service with a collection of available clothes from another secondary service provider (e.g. a dress vendor). In order to obtain these sub-services, the primary service provider may need to supply certain information on the user, such as his/her current position as well as age, gender, preferences, etc., to the secondary service providers, totally out of control of the user.

When subscribing to a web service, the user is generally aware of the primary service provider and has full knowledge and control of the information he/she gives thereto. The user is free to withdraw from the service subscription or to refrain from giving any required information, e.g. if he/she finds it inappropriate, uncomfortable or unsafe. However, the user has no knowledge whatsoever of any utilised secondary service providers and has no control of what information that might be provided thereto. Moreover, potentially sensitive information may be conveyed over an insecure link between the primary and secondary service providers, such that any illicit party is able to pick up that information. In any case, the user cannot feel assured that the information is communicated safely.

It is thus desirable for network operators and web service providers sharing potentially sensitive information with secondary service providers when delivering web services, to ensure the identity and authenticity of both the end-user and the service. It is also desirable to ensure that the secondary service provider only gets the information required to perform the service and which the user has allowed. Naturally, the service-consuming user also wants to feel comfortable and safe when using such aggregated web services, as explained above.

Solutions are available today to federate identities of users among service providers (e.g. as standardized by Liberty Alliance or developed by OpenID). However, these solutions are primarily concerned with identification of the end-user, and it is then assumed that there is a one-to-one relationship between the end-user and the primary service provider, or between the primary service provider and each secondary service provider involved. Therefore, these solutions are not open to ad-hoc service creation, such as aggregated web services as described above.

### SUMMARY

It is an object of the present invention to address the problems outlined above. Further, it is an object to provide a solution that enables security, integrity and/or privacy when terminal users in a communication network access and consume aggregated web services from a primary service provider, when one or more secondary service providers are involved. These objects and others may be obtained by providing a method and apparatus according to the independent claims attached below.

According to one aspect, the invention includes a method of checking an aggregated web service requested by a terminal user. A web service authentication node receives and stores a published description of the aggregated web service, which is offered from a primary web service provider and involves one or more sub-services offered from one or more secondary web service providers. When the web service authentication node receives a request for the aggregated web service that has been made by the user, it is checked whether the sub-services and secondary service providers of the aggregated web service are deemed acceptable or safe for the user according to a policy of the requesting user. The aggregated web service is authenticated if all of the sub-services and secondary service providers are deemed acceptable or safe.

According to another aspect, the invention includes a web service authentication node comprising a receiving unit adapted to receive and store a published description of an aggregated web service offered from a primary web service provider and involving one or more sub-services offered from one or more secondary web service providers, and to receive a request for the aggregated web service that has been made by a terminal user. The web service authentication node further comprises a checking unit adapted to check whether the sub-services and secondary service providers of the aggregated web service are deemed acceptable or safe for the user according to a policy of the requesting user, and an authenticating unit adapted to authenticate the aggregated web service if all of the sub-services and secondary service providers are deemed acceptable or safe.

Different embodiments are possible in the method and apparatus above. For example, if any of the sub-services and secondary service providers is deemed unacceptable or unsafe, the authenticating unit may send a response to the user, either rejecting the request or warning the user that the aggregated web service is deemed unsafe.

The checking unit may compare the service description of the requested web service with the policy. The service description may specify what type of information is required for each involved sub-service, and the policy may specify what type of information each involved sub-service is allowed to access.

The receiving unit may receive the service request as forwarded from a web service portal to which the user has sent the service request, or as forwarded from the primary web service provider, or from a packet inspection function configured to detect and analyse packets from the user. The packet inspection function may be a DPI function installed at a GGSN of a used mobile access network.

The receiving unit may further store the service description in an authentication database in the web service authentication node. The checking unit may retrieve the policy from the authentication database if stored therein, or from a database connected to PCRF or P-CSCF, or from an HSS. The receiving unit may also send an affirmative response to the user optionally disclosing all sub-services required for the service request.

The checking unit may further identify the user in the service request by means of his/her IP-address or SIP URI or HTTP URI. The authenticating unit may also authorise the user towards the primary web service provider. One or more of the sub-services in a first sub-level may be an aggregated web service requiring sub-services in a second sub-level from further secondary web service providers, and the sub-services in the second sub-level may then be examined and authenticated recursively.

Further possible features and benefits of the present invention will be explained in the detailed description below.

### BRIEF DESCRIPTION OF THE DRAWINGS

The invention will now be explained in more detail by means of exemplary embodiments and with reference to the accompanying drawings, in which:

FIG. 1 is a schematic view illustrating how a primary service provider utilises plural secondary service providers for delivering an aggregated web service, according to the prior art.

FIG. 2 is a schematic view illustrating a first exemplary network structure using a web service authentication node when providing an aggregated web service, in accordance with one embodiment.

FIG. 3 is a flow chart illustrating a procedure for checking an aggregated web service, in accordance with another embodiment.

FIG. 4 is a schematic view illustrating a second exemplary network structure using a web service authentication node when checking an aggregated web service, in accordance with yet another embodiment.

FIG. 5 is a schematic view illustrating a third exemplary network structure using a web service authentication node when checking an aggregated web service, in accordance with yet another embodiment.

FIG. 6 is a block diagram illustrating a web service authentication node in more detail, according to yet another embodiment.

### DETAILED DESCRIPTION

Briefly described, the present invention can be used for providing security, integrity and/or privacy for terminal users when requesting an aggregated web service involving a visible primary web service provider and one or more invisible secondary web service providers, as seen from the user's perspective. The primary web service provider enables the aggregated web service when requested by a user, and the secondary web service providers enable any sub-services necessary for the aggregated one. One or more of the sub-services in a first “sub-level” may in turn be an aggregated web service as well, requiring sub-services in a second sub-level from further secondary web service providers, and so forth.

In a first phase, the primary web service provider publishes the aggregated web service, including a service description of all comprised secondary web service providers and corresponding sub-services, possibly in multiple sub-levels as described above. The service description may be provided as a BPEL script or similar. In the case of multiple sub-levels of sub-services, the service description may comprise a first BPEL script or similar with sub-services in a first sub-level and a second BPEL script or similar with sub-services in a second sub-level required for a sub-service in the first sub-level, and so forth. It should be noted that the present invention is not limited to using BPEL scripts as service description and any other corresponding or similar standard may be used as service descriptions. For example, a service description in this context could also be provided as an XML document or the like.

A web service authentication node stores the service description in an authentication database in which policies regarding usage of specific web services may also be stored for different users. For example, such a policy may dictate that a certain category of users or subscribers, e.g. “bronze users”, may be allowed to consume certain web services from certain web service providers.

In a second phase, the user makes a request for the aggregated web service which request is forwarded to the web service authentication node. The request may be placed at a web service portal such as the above-mentioned WRVN using the UDDI function. The requested web service is then identified and the previously stored service description is retrieved from the authentication database.

It is also checked whether the secondary web service providers and corresponding sub-services comprised in the requested service are acceptable to the requesting user according to a policy valid for that user. If the policy dictates that all sub-services in the previously stored service description are acceptable and allowed for that user, the aggregated web service can be authenticated and consumed by the user. If not, the service request may be denied or a warning can be sent to the user indicating that the service is not safe according to the user's policy. It is also possible to differentiate the sub-services such that some sub-services (e.g. black-listed web services) are blocked unconditionally, whereas others (e.g. unknown web services) may be up to the user to allow.

Thus, the previously stored policy valid for the requesting user and the service description can together testify that any information on the user can be safely submitted to the secondary web service providers involved in the aggregated web service, thereby validating the invisible secondary service providers.

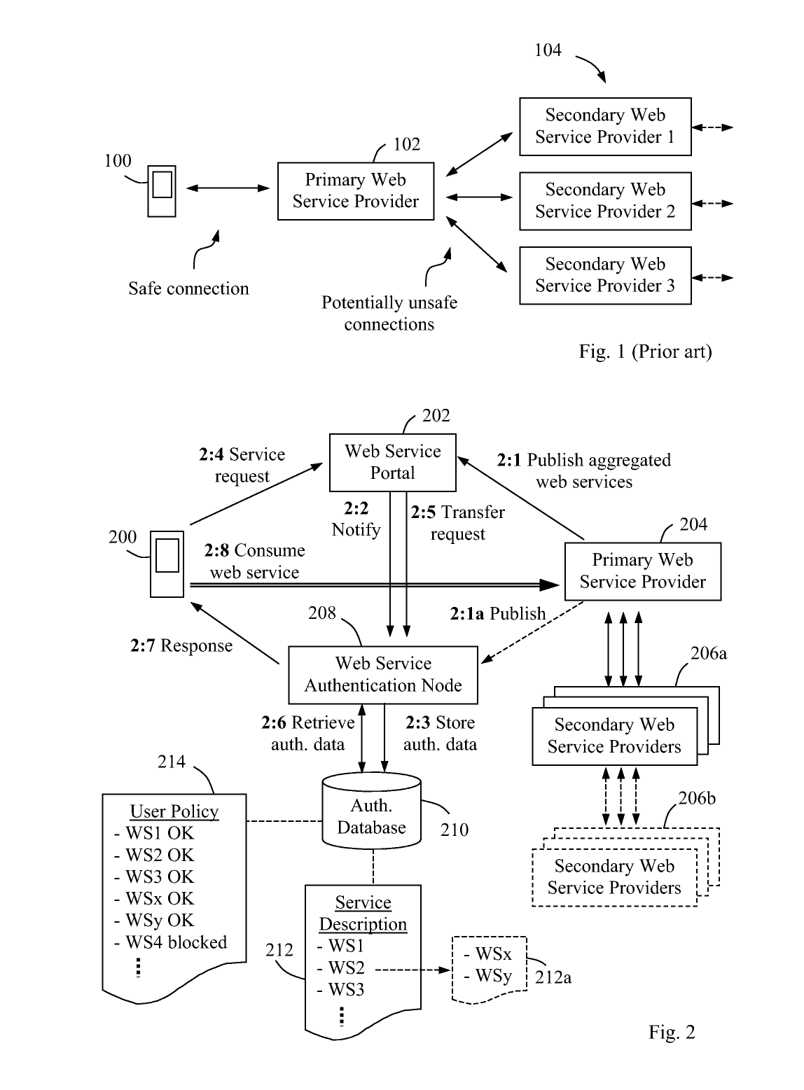

A first exemplary network structure and procedure for checking an aggregated web service, is schematically illustrated in FIG. 2. A user operating a communication terminal 200, hereafter simply called “user 200”, will access the aggregated web service by means of a service node referred to as a web service portal 202, which could be a WRVN having the UDDI function.

The aggregated web service is offered from a primary web service provider 204 which will need sub-services offered from a plurality of secondary web service providers 206a in a first sub-level, which in turn may need further sub-services offered from further secondary web service providers 206b in a second sub-level, as illustrated in the figure.

In practice, the web service portal 202 may be controlled by the operator of the access network or IMS network used (not shown), whereas the web service providers 204, 206a and 206b may generally be controlled by parties outside the access network and/or IMS network. In another example, the IMS or access network operator may control the primary web service provider 204 while the secondary web service providers 204, 206a and 206b may be controlled by parties outside the access or IMS network.

In order to accomplish the inventive procedure and node structure, a “web service authentication node” 208 is introduced. As briefly described above, the procedure can be seen as comprising two phases: a first provisioning phase for storing information on the aggregated web service and a second run-time phase for processing the service request from user 200.

In the first phase, primary provider 204 publishes the aggregated web service by sending a service description to web service portal 202, in a first step 2:1, e.g. in the form of one or more BPEL scripts or similar. The service description identifies all sub-services, possibly in multiple sub-levels, and corresponding secondary web service providers 206a, 206b needed for the aggregated web service.

The web service portal 202 will then notify the web service authentication node 208 by forwarding the published service description thereto, in a next step 2:2. In addition, primary provider 204 may publish the aggregated web service by sending the service description directly to authentication node 208, as illustrated by an optional step 2:1a. In that case, step 2:2 will be superfluous. Having received the published description of the aggregated web service, authentication node 208 stores the service description (e.g. BPEL script(s) or similar) in an authentication database 210, in a following step 2:3. The service description may thus include identifiers for all sub-services and/or secondary web service providers needed for the requested web service. The service description may further include what type of user information is required for each respective secondary web service.

Database 210 may be a local database in authentication node 208, or an existing data storage in the operator's network such as the HSS or a database connected to the P-CSCF node or to a PCRF (Policy and Charging Rule Function) node. PCRF is a policy control node responsible for authorisation and admission of communication sessions for terminals in the network, as defined by 3GPP.

The stored service description 212 thus basically contains a list of sub-services and corresponding secondary web service providers 206a, 206b, denoted here as WS1, WS2, WS3 . . . , as well as a service identification. In this example, sub-service WS2 in turn requires further sub-services WSx and WSy in a second sub-level 212a, which are therefore also included in the service description 212.

In this example, a policy 214 valid for the requesting user has also been stored in the authentication database 210, although not shown as a specific step in this procedure. If the existing HSS, P-CSCF or PCRF is used, this type of information is normally available therein. If a local authentication database 210 in authentication node 208 is used, policy information can be fetched from any of the above storages which are generally used for holding policies and subscriber profiles.

The policy 214 basically contains a list of allowed and trusted web service providers and/or web services, exemplified here as “WS1 OK”, “WS2 OK”, “WS3 OK”, “WSx OK” and “WSy OK”. The policy 214 may further specify which type of user information each service is entitled to access. For example, the list of web services in policy 214 may further include an information type (“datablock”) allowed for each service, basically in the manner of: “WS1 OK for datablocks a,b”, “WS2 OK for datablocks a,c”, and so forth.

This type of security information can thus be defined in subscriber profiles or the like. The policy 214 may further contain a list of one or more web service providers and/or web services that are not allowed and/or trusted, exemplified here as “WS4 blocked”, being basically a “blacklist”. It is further possible to forbid a service to access a certain information type (datablock), such as: “WS4 blocked for datablocks a,b,c”. The policy 214 may be valid for a user category or subscription class, e.g. “bronze”, “silver”, “gold” or “platinum subscribers”, to which the current user belongs according to his/her subscription. The policy 214 may also be specifically composed or customised for the user in question.

In the second phase of the illustrated procedure, the user 200 sends a request for the aggregated web service to web service portal 202, in a step 2:4. Before that, the user may have searched for web services in portal 202, e.g. using the UDDI function, to find the aggregated web service which was previously published in step 2:1. Portal 202 then forwards the service request to the introduced authentication node 208 in a following step 2:5.

Authentication node 208 then identifies the requested web service and retrieves authentication data from authentication database 210, in a further step 2:6, in order to determine whether the requested web service is deemed safe and can be accepted for the requesting user. In this example, the retrieved authentication data includes the service description 212, 212a and the policy 214, of which the latter may be fetched from an HSS or from a database via the P-CSCF or PCRF serving the user, depending on the implementation.

Authentication node 208 thus checks that all sub-services and corresponding secondary web service providers in service description 212, 212a are acceptable according to the policy 214. If a sub-service in the service description is an aggregated service, the required individual sub-services can be examined and authenticated recursively in the same manner. In this example, policy 214 indicates that all sub-services WS1, WS2, WS3, as well as the sub-services WSx, WSy required for sub-service WS2, are acceptable (OK) to the concerned user. As mentioned above, the policy 214 may be valid for a subscriber category (e.g. “gold”) to which the user belongs, or may have been configured specifically for that user.

Thereafter, authentication node 208 sends a suitable response to user 200 in a further step 2:7, the contents of which will naturally depend on the outcome of the previous step 2:6. If a sub-service/secondary web service provider in the service description 212 is found to be unacceptable according to the policy 214, or simply not safe or trusted e.g. by having a sub-service not specified in the policy, the requested web service will be deemed unsafe altogether. In that case, the response of step 2:7 may deny access to the requested web service, or at least provide a warning that the web service is deemed unsafe leaving it up to the user to consume the service or not.

On the other hand, if all sub-services/secondary web service providers in the service description 212 are found to be acceptable according to the policy 214, as in the present example, the response of step 2:7 may simply authenticate the web service. Thereby, the user can safely consume the aggregated web service, in a final step 2:8. In addition, having identified the user and checked his/her policy, authentication node 208 may also authenticate the user towards service provider 204 by sending a suitable message (not shown) thereto.

The response of step 2:7 may optionally disclose all sub-services required for the service request, or at least those not specified in the policy 214 which thereby cannot be deemed safe automatically, such that the user is free to decide whether he/she can accept them anyway or not. Further, the sub-services may be displayed for the user in the response 2:7, even if all are found to be acceptable according to the policy 214. The display of sub-services in the response 2:7, e.g. in multiple sub-levels, may include for each service: a title or identity, a brief description of the service, and one or more links (e.g. URIs) to the corresponding primary and secondary service providers for further information on their respective web services. The display of sub-services in the response 2:7 may further include what type of user information each respective service requires.

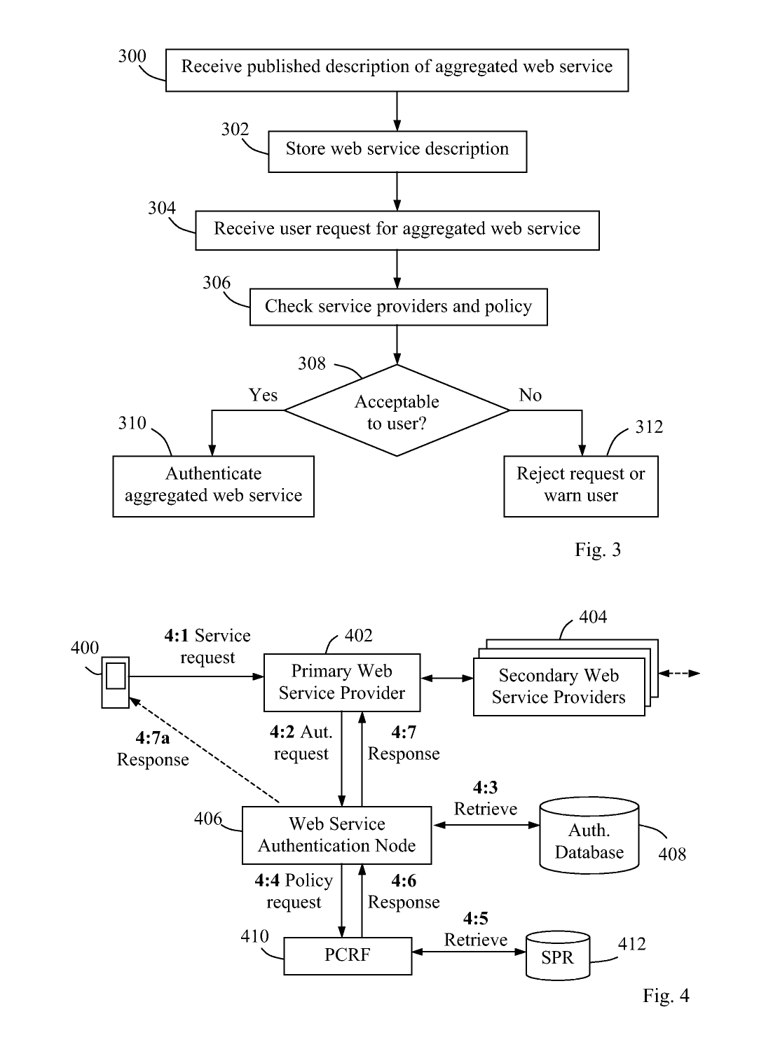

A procedure for checking an aggregated web service requested by a terminal user, will now be described with reference to the flow chart shown in FIG. 3, and with further reference back to FIG. 2. The shown procedure is basically performed in a web service authentication node, such as node 208 of FIG. 2, although the present invention may be implemented in any suitable node, existing or new, having the described functionality of the web service authentication node.

In a first step 300, a published description of the aggregated web service is received, either as forwarded from the web service portal 202 or directly from the primary web service provider 204. In a next step 302, a service description (e.g. one or more BPEL scripts or similar) is stored in the authentication database 210, containing a list of all sub-services/secondary web service providers 206a,b needed for the aggregated web service, and possibly also the type of user information each respective service requires. Steps 300 and 302 above basically represent the first phase of the procedure.

In the second phase, a request for the aggregated web service that has been made by user 200 is received, in a step 304, e.g. as forwarded from web service portal 202 as in FIG. 2 or from any other node in the network having detected the request. As will be described in more detail below, the user's service request may be received as an authentication request from the primary web service provider or from an access network node having detected the request.

Then, the requested web service is identified and the sub-services and secondary service providers of the requested web service and the policy of the requesting user are checked in a further step 306, by retrieving relevant information in the service description and valid policy from authentication database 210, as described above for FIG. 2 (possibly in a recursive manner for multiple sub-levels).

It is then determined whether the requested web service can be accepted for the user, in a following step 308, by comparing the sub-services and secondary service providers in the service description with the policy. In this step, consideration may also be made to what type of user information each sub-service requires and whether the policy allows for that. If the policy dictates that none of the sub-services and secondary service providers in the service description is deemed unsafe or unacceptable for the user, possibly considering the type of user information required, the requested web service is authenticated in a step 310, and an affirmative response can be sent to user 200. Otherwise, a response is sent to the user 200 in a step 312, either rejecting the request altogether or warning the user that the requested web service is deemed unsafe. As mentioned above, this mechanism can also be used to authorise the user towards the primary web service provider having received the service request from the user.

The procedure generally illustrated in FIG. 3 can be realised in different ways, one example being according to the network structure and steps disclosed in FIG. 2 using a web service portal. Alternatively, the user may contact the primary web service provider directly and request an aggregated web service therefrom. The primary web service provider may then in turn contact the web service authentication node to find out whether the user's policy can accept the requested service, i.e. including all its required sub-services, and to obtain any user information needed to execute and deliver the requested service.

In another example, the check as to whether the user's policy can accept the requested service can also be initiated by a packet inspection function in the used access network which is configured to detect and analyse packets from the user, sometimes referred to as “packet sniffing” or “Deep Packet Inspection DPI”. The packet inspection function may thus detect an IP address in the packet header and identify its corresponding web-service/service provider, e.g. using the UDDI function. In 3GPP, this function can be installed at the node GGSN (GPRS Gateway Support Node) in a mobile access network through which all outgoing packets from the user pass, e.g. on the outgoing Gy interface.

When detecting a request for an aggregated web service, the packet inspection function can contact the above-described web service authentication node to find out whether the user's policy can accept the requested service. If not, the packet inspection function or the web service authentication node may trigger a suitable service blocking mechanism or a warning message to the user.

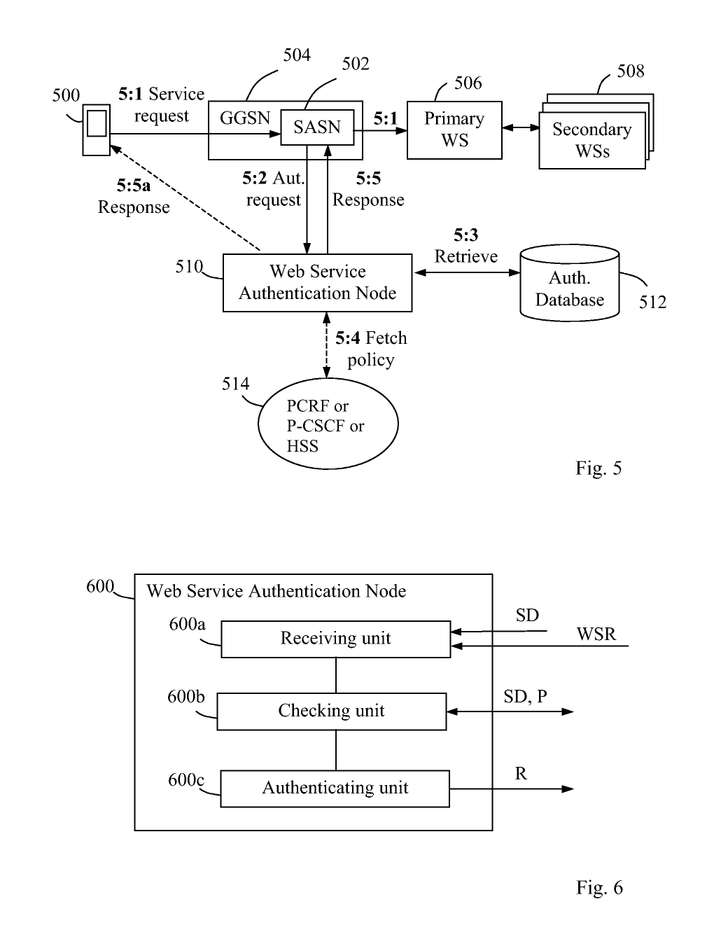

Some further practical implementation examples for realising the above-described solution will now be briefly described with reference to FIG. 4 illustrating a second exemplary network structure and procedure, and to FIG. 5 illustrating a third exemplary network structure and procedure. In FIG. 4, a terminal user 400 accesses a primary web service provider 402 directly and requests an aggregated web service therefrom, in a first step 4:1, without using a web service portal as for FIG. 2. Being aggregated, the requested service requires further sub-services from secondary web service providers 404, possibly involving sub-services in multiple sub-levels (dashed arrow). It is assumed that the aggregated web service has been published previously in a provisioning phase and that a service description (e.g. as BPEL script(s) or similar) has been received at a web service authentication node 406 and stored in an authentication database 408, e.g. in the manner described above as steps 2:1-2:3 in FIG. 2.

In a next step 4:2, primary web service provider 402 sends an authentication request to authentication node 406 including identifiers for the user and the requested service, respectively. In this context, sending the authentication request in step 4:2 is basically equivalent to sending (i.e. forwarding) the service request to authentication node 406, generally corresponding to step 304 in FIG. 3. The user may be identified in the service/authentication request by means of his/her IP-address or some other suitable unique identifier such as a SIP (Session Initiation Protocol) URI (Universal Resource Locator), HTTP (HyperText Transfer Protocol) URI, or similar.

The web service authentication node 406 then retrieves the service description in authentication database 408, in a step 4:3. In this example, a PCRF node 410 holds the prevailing policy valid for the user 400 in a policy database 412 which may be an SPR (Subscription Profile Repository) or a PCRF internal policy database. Thus, authentication node 406 sends a policy request for the user, including at least the user identifier, to PCRF node 410 in a further step 4:4.

When receiving the policy request, PCRF node 410 identifies the user (e.g. by his/her IP-address, SIP URI, HTTP URI as mentioned above), and a user authentication mechanism may be employed to ensure that the user is properly identified, such as AAA (Authentication, Authorisation, Accounting) or Diameter. PCRF node 410 then retrieves the user's valid policy from policy database 412, in a step 4:5, and may send the policy as a response to the authentication node 406, in a next step 4:6, according to one alternative. Authentication node 406 is then able to compare the received policy with the service description retrieved in step 4:3 to determine whether the policy allows for the requested service including all its required sub-services to obtain necessary user information.

According to another alternative, the policy request may include the service description, and in that case PCRF node 410 can compare the policy with the service description and determine whether the service can be allowed and/or deemed safe. The results (e.g. simply “allowed” alt. “rejected”, or “safe” alt. “unsafe”) would then be communicated to the authentication node 406 in step 4:6.

In either case, authentication node 406 finally responds to the primary web service provider 402 by sending the message thereto in a last step 4:7, indicating whether the service can be allowed or not. Optionally, authentication node 406 may also send a similar message to the user 400 as well, as shown by a dashed step 4:7a, e.g. indicating denied access to the requested web service or a warning that it is deemed unsafe.

The example of FIG. 4 can be modified for the case of using an IMS network when the above-described web service authentication function could be implemented in an existing IMS node. The information on authorised web services could then be stored in the HSS node, P-CSCF, a specific web service authentication node, or even in all of the above. For example, a web service authentication node could be used as a proxy between P-CSCF and the primary web service provider.

FIG. 5 illustrates an example where a packet inspection function is used for checking whether an aggregated service requested by a terminal user 500 can be allowed according to the user's policy. In this example, the packet inspection function is represented by a DPI block 502 configured to detect and analyse packets from the user, which in this case is installed at a GGSN 504 of a used mobile access network.

In a first step 5:1, the user 500 accesses a primary web service provider 506 directly and requests an aggregated web service therefrom that requires further sub-services from secondary web service providers 508, as similar to FIG. 4. Again, it is assumed that the aggregated web service has been published previously and that a corresponding service description has been received at a web service authentication node 510 and stored in an authentication database 512.

The web service request of step 5:1 is detected by the DPI block 502 which then sends an authentication request to authentication node 510, in a following step 5:2. As similar to the example of FIG. 4, sending the authentication request in step 5:2 is basically equivalent to sending (i.e. forwarding) the detected service request to authentication node 510, again corresponding to step 304 in FIG. 3.

Authentication node 510 then retrieves the service description from database 512 in a step 5:3 and further retrieves a policy of the user, either from the database 512 if stored therein or from a PCRF, P-CSCF or HSS 514, illustrated by a dashed step 5:4, depending on the implementation as described above. When the authentication check is completed, authentication node 510 sends a suitable response message to the DPI block in a final step 5:5, which then may take suitable actions to reject or allow the web service. Likewise to the example of FIG. 4, authentication node 510 may also send a similar message to the user 500 as well in a step 5:5a, e.g. indicating allowed or denied access or a warning that the requested web service is deemed unsafe.

In the above examples, the user has operated a mobile terminal in a mobile access network. The present invention can also be implemented for fixed terminals and networks as well, basically using the same or corresponding building blocks as described above. Thus, in a fixed access network, a RACS (Resource and Admission Control Subsystem) contains functionalities similar to the PCRF, and a NASS (Network Attachment SubSystem) is the equivalent to an SPR holding subscriber policy data. Further, an IMS system can be used for fixed networks in the same manner as described above for 3GPP (or the equivalent), e.g. using the HSS for subscription data, and the NASS has direct access to the HSS. The present invention can thus be used for a so-called fixed NGN (Next Generation Network) as well as for a mobile 3GPP network.

FIG. 6 is a block diagram illustrating a web service authentication node 600 in more detail, according to yet another embodiment. Authentication node 600 is basically configured to perform the functions in one of authentication nodes 208, 406 and 510 discussed above.

Authentication node 600 comprises a receiving unit 600a adapted to receive and store a published description SD of an aggregated web service offered from a primary web service provider and involving one or more sub-services offered from one or more secondary web service providers. Receiving unit 600a is also adapted to receive a request WSR for the aggregated web service that has been made by a terminal user.

Authentication node 600 further comprises a checking unit 600b adapted to check whether the sub-services and secondary service providers of the aggregated web service are deemed acceptable or safe for the user according to a policy P of the requesting user. Checking unit 600b may then retrieve and compare the service description SD of the requested web service and the policy P.

Authentication node 600 further comprises an authenticating unit 600c adapted to authenticate the aggregated web service in a suitable response R if all of the sub-services and secondary service providers are deemed acceptable or safe. If not, the response R may indicate denied access or a warning to the user that the requested web service is deemed unsafe. Such a response R may be sent to the user and/or any network node involved in the process or to the primary web service provider, as exemplified above.

It should be noted that FIG. 6 merely illustrates the various functional units 600a-c in a logical sense, while the skilled person is free to implement these functions in practice using any suitable software and hardware means. Thus, the present invention is generally not limited to the shown structure of the authentication node 600.

The advantages that can be obtained by means of the above-described embodiments may include centralised policy management, the network operator gains control of how user information and content is used and of service requests from third parties, the operator can also detect and block unauthorised and/or unreliable web services. Further, the user will gain knowledge of how his/her user data is used and he/she will also be able to control access to sensitive data, thereby obtaining added security, integrity and/or privacy.

Hence, by feeling safe when using web services the users will be more inclined to generally access and consume web services which will potentially result in increased service usage, more satisfied users and revenue for network operators and service providers.

While the invention has been described with reference to specific exemplary embodiments, the description is in general only intended to illustrate the inventive concept and should not be taken as limiting the scope of the invention. Although the concepts of 3GPP, IMS, PCRF, P-CSCF, HSS, DPI and BPEL have been used when describing the above embodiments, any other similar suitable standards, protocols and network elements may basically be used as described herein. The present invention is generally defined by the following independent claims.

1-24. (canceled)

25. A method of checking an aggregated web service requested by a terminal user, comprising the following steps executed by a web service authentication node:
receiving and storing a published description of the aggregated web service, said aggregated web service being offered from a primary web service provider and involving one or more sub-services offered from one or more secondary web service providers;
receiving a request for the aggregated web service that has been made by the user;
checking whether the sub-services and secondary service providers of the aggregated web service are deemed acceptable or safe for the user according to a policy of the requesting user; and
authenticating the aggregated web service if all of said sub-services and secondary service providers are deemed acceptable or safe.

26. A method according to claim 25, wherein if any of said sub-services and secondary service providers are deemed unacceptable or unsafe, a response is sent to the user, either rejecting the request or warning the user that the aggregated web service is deemed unsafe.

27. A method according to claim 25, wherein said checking step includes comparing the service description of the requested web service with said policy.

28. A method according to claim 25, wherein the service description specifies what type of information is required for each involved sub-service.

29. A method according to claim 25, wherein the policy specifies what type of information each involved sub-service is allowed to access.

30. A method according to claim 25, wherein the service request is received as forwarded from a web service portal to which the user has sent the service request, or as forwarded from the primary web service provider, or from a packet inspection function configured to detect and analyze packets from the user.

31. A method according to claim 30, wherein said packet inspection function is a DPI function installed at a GGSN of a used mobile access network.

32. A method according to claim 25, wherein said receiving and storing step includes storing the service description in an authentication database in the web service authentication node.

33. A method according to claim 25, wherein said checking step includes retrieving the policy from the authentication database if stored therein, or from a database connected to PCRF or P-CSCF, or from an HSS.

34. A method according to claim 25, wherein said authenticating step includes sending an affirmative response to the user optionally disclosing all sub-services required for the service request.

35. A method according to claim 25, wherein the user is identified in the service request by an IP-address or SIP URI or HTTP URI.

36. A method according to 25, wherein the user is authorized towards the primary web service provider.

37. A method according to claim 25, wherein one or more of said sub-services in a first sub-level is an aggregated web service requiring sub-services in a second sub-level from further secondary web service providers, and said sub-services in the second sub-level are examined and authenticated recursively.

38. A web service authentication node, comprising:
a receiving unit adapted to receive and store a published description of an aggregated web service offered from a primary web service provider and involving one or more sub-services offered from one or more secondary web service providers, and to receive a request for the aggregated web service that has been made by a terminal user;
a checking unit adapted to check whether the sub-services and secondary service providers of the aggregated web service are deemed acceptable or safe for the user according to a policy of the requesting user; and
an authenticating unit adapted to authenticate the aggregated web service if all of said sub-services and secondary service providers are deemed acceptable or safe.

39. A web service authentication node according to claim 38, wherein, if any of said sub-services and secondary service providers are deemed unacceptable or unsafe, the authenticating unit is further adapted to send a response to the user, either rejecting the request or warning the user that the aggregated web service is deemed unsafe.

40. A web service authentication node according to claim 38, wherein the checking unit is further adapted to compare the service description of the requested web service with said policy.

41. A web service authentication node according to claim 38, wherein the receiving unit is further adapted to receive the service request as forwarded from a web service portal to which the user has sent the service request, or as forwarded from the primary web service provider, or from a packet inspection function configured to detect and analyze packets from the user.

42. A web service authentication node according to claim 41, wherein the packet inspection function is a DPI function installed at a GGSN of a used mobile access network.

43. A web service authentication node according to 38, wherein the receiving unit is further adapted to store the service description in an authentication database in the web service authentication node.

44. A web service authentication node according to claim 38, wherein the checking unit is further adapted to retrieve the policy from the authentication database if stored therein, or from a database connected to PCRF or P-CSCF, or from an HSS.

45. A web service authentication node according to claim 38, wherein the authenticating unit is further adapted to send an affirmative response to the user optionally disclosing all sub-services required for the service request.

46. A web service authentication node according to claim 38, wherein the checking unit is further adapted to identify the user in the service request by an IP-address or SIP URI or HTTP URI.

47. A web service authentication node according to claim 38, wherein the authenticating unit is further adapted to authorize the user towards the primary web service provider.

48. A web service authentication node according to claim 38, wherein one or more of said sub-services in a first sub-level is an aggregated web service requiring sub-services in a second sub-level from further secondary web service providers, and said sub-services in the second sub-level are examined and authenticated recursively.
